(19) United States
(12) Patent Application Publication
(10) Pub. No.: US 2024/0331898 A1
(43) Pub. Date: Oct. 3, 2024

(54) CORROSION-RESISTANT AND HIGH-PERFORMANCE SINTERED NEODYMIUM-IRON-BORON MAGNET, PREPARATION METHOD, AND USE THEREOF

(71) Applicants: YANTAI ZHENGHAI MAGNETIC MATERIAL CO., LTD., Shandong (CN); JIANGHUA ZHENGHAI MINMETALS ADVANCED MATERIALS CO., LTD., Hunan (CN)

(72) Inventors: Zhiqiang LI, Yantai, Shandong (CN); Yunying JIANG, Yantai, Shandong (CN); Lei LIU, Yantai, Shandong (CN); Zhongxin AN, Yantai, Shandong (CN); Yuhao DONG, Yantai, Shandong (CN)

(21) Appl. No.: 18/577,502

(22) PCT Filed: Jul. 7, 2022
(86) PCT No.: PCT/CN2022/104307

§ 371 Date: Jan. 8, 2024

(30) Foreign Application Priority Data
Jul. 8, 2021 (CN) 202110774881.2

(51) Int. Cl. H01F 1/057; B22F 3/16; B22F 3/24; B22F 9/02; B22F 9/04; C22C 38/00; C22C 38/06; C22C 38/10; C22C 38/14; C22C 38/16

(52) U.S. Cl. CPC H01F 1/0577; B22F 3/16; B22F 3/24; B22F 9/023; B22F 9/04; C22C 38/002; C22C 38/005; C22C 38/06; C22C 38/10; C22C 38/14; C22C 38/16; B22F 2003/248; B22F 2201/10; B22F 2202/05; B22F 2998/10; B22F 2999/00; C22C 2202/02

(57) ABSTRACT

A corrosion-resistant and high-performance sintered neodymium-iron-boron magnet, a preparation method therefor, and a use thereof are provided. The sintered neodymium-iron-boron magnet is prepared by pulverizing, forming, and sintering. The sintered neodymium-iron-boron magnet contains: 28.5 wt % to 32.5 wt % of R; 0.88 wt % to 0.94 wt % of B; 0.1 wt % to 0.3 wt % of Ga; 1.0 wt % to 3.0 wt % of Co; and 400 ppm to 1000 ppm of O. The sintered neodymium-iron-boron magnet capable of inhibiting reduction of coercive force and improving the coercive force can be obtained by means of an oxygen adding operation, and meanwhile, the corrosion resistance of the magnet can be improved.

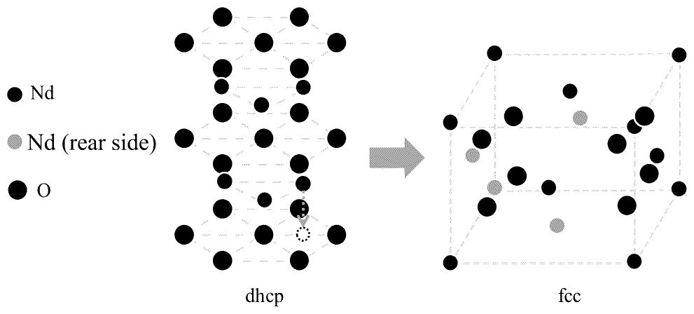

### CROSS-REFERENCE TO RELATED APPLICATIONS

The present application is a U.S. national stage entry of PCT international application No. PCT/CN2022/104307, filed on Jul. 7, 2022, which claims priority to the prior application with the Chinese patent application No. 202110774881.2 and entitled “CORROSION-RESISTANT AND HIGH-PERFORMANCE SINTERED NEODYMIUM-IRON-BORON MAGNET, PREPARATION METHOD, AND USE THEREOF” filed to the China National Intellectual Property Administration on Jul. 8, 2021, the content of which is incorporated herein by reference in its entirety.

### TECHNICAL FIELD

The present disclosure relates to the field of rare earth permanent magnet materials, and particularly, to a corrosion-resistant and high-performance sintered neodymium-iron-boron magnet, a preparation method, and use thereof.

### BACKGROUND

Rare earth permanent magnet materials have become indispensable supporting materials for modern economy, science and technology. Among them, sintered neodymium-iron-boron permanent magnets have been widely used in the fields of wind power, automobiles, home appliances, electric motors, consumer electronics, medical devices, and the like. A sintered neodymium-iron-boron magnet is mainly composed of an R₂Fe₁₄B main phase, an R-rich phase, and a B-rich phase. The R₂Fe₁₄B main phase is a ferromagnetic material with high saturation magnetization and anisotropic magnetic field, and is the basis for magnetic properties of the sintered neodymium-iron-boron magnet. Sintered neodymium-iron-boron magnets in the prior art tend to form B-rich phases (Nd_{1.1}Fe₄B₄ compounds) at grain boundaries, resulting in a decrease in residual flux density Br and coercivity Hcj of the sintered neodymium-iron-boron magnets.

In recent years, neodymium-iron-boron permanent magnet manufacturers have also been committed to the research of low-B formulas and supporting technologies thereof in order to achieve stable mass production. Among them, the patent document CN105074837B discloses a sintered neodymium-iron-boron magnet comprising B having a content of not less than 0.86 wt % and not more than 0.90 wt %, but comprising Ga having a content of not less than 0.4 wt % and not more than 0.6 wt %. The patent document CN105960690B discloses a sintered neodymium-iron-boron magnet, which requires that the content of Ga is 0.3%-0.8%, the content of B is 0.93%-1.0%, and the content of Ti is 0.15%-0.28%; a procedure of preparing an alloy powder comprises a procedure of preparing a Ti hydride powder; and the alloy powder is mixed with the Ti hydride powder to give a powder. The patent document CN106716571B discloses a preparation method of a sintered neodymium-iron-boron magnet, which requires that the content of both Cu and Ga is more than or equal to 0.2%, Nb and/or Zr are present and have a content of less than or equal to 0.1%, and the content of B is 0.85%-0.93%; a heat treatment procedure comprises heating starting materials of the magnet to a temperature of not lower than 730° C. and not higher than 1020° C., then cooling to 300° C., and heating the starting materials to a temperature of not lower than 440° C. and not higher than 550° C. for low-temperature treatment.

Although the technical solutions described above aim to improve the coercivity of the sintered neodymium-iron-boron magnets by means of reducing the concentration of B in the sintered neodymium-iron-boron magnets, lowering the ratio of main phase grains, thickening grain boundary phases, and the like, there is still a phenomenon that grain boundaries of sintered neodymium-iron-boron magnets with low-B systems will become thicker. Moreover, the thicker grain boundary phases make Nd and Fe in the magnets easier to be oxidized, resulting in deterioration of corrosion resistance of the magnets. Therefore, it is urgently needed to further improve the magnetic properties and corrosion resistance of sintered neodymium-iron-boron magnets, reduce cost, and the like.

### SUMMARY

To ameliorate the problems in the prior art, the present disclosure provides a sintered neodymium-iron-boron magnet, wherein the sintered neodymium-iron-boron magnet is manufactured by pulverizing, molding, and sintering a sintered neodymium-iron-boron magnet composition in an inert atmosphere.

According to an embodiment of the present disclosure, the sintered neodymium-iron-boron magnet comprises:
R having a content of not less than 28.5 wt % and not more than 32.5 wt %;
B having a content of not less than 0.88 wt % and not more than 0.94 wt %;
Ga having a content of not less than 0.1 wt % and not more than 0.3 wt %;
Co having a content of not less than 1.0 wt % and not more than 3.0 wt %;
O having a content of not less than 400 ppm and not more than 1000 ppm; and
the balance being Fe and inevitable impurities.

Preferably, the R is selected from neodymium (Nd), or neodymium (Nd) and at least one of the following rare earth elements: rare earth elements such as lanthanum (La), cerium (Ce), praseodymium (Pr), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), scandium (Sc), yttrium (Y), and the like.

According to an embodiment of the present disclosure, B, Ga, and O in the sintered neodymium-iron-boron magnet have a relationship as follows: 0.25×(0.98−[B])+0.1×(0.5−[Ga])<[O], wherein [B], [Ga], and [O] represent mass percentages of B, Ga, and O in the sintered neodymium-iron-boron magnet, respectively.

According to an embodiment of the present disclosure, the content of the inevitable impurities is not less than 0 wt % and not more than 2.0 wt %, and preferably not less than 0.1 wt % and not more than 0.8 wt %.

According to an embodiment of the present disclosure, the sintered neodymium-iron-boron magnet composition contains no more than 200 ppm of O. Preferably, the sintered neodymium-iron-boron magnet composition further contains a desired stoichiometric amount of elements such as R, B, Ga, Co, Fe, and the like.

According to an embodiment of the present disclosure, the sintered neodymium-iron-boron magnet comprises an R₂Fe₁₄B main phase, an R-rich phase, and a B-rich phase.

According to an embodiment of the present disclosure, the sintered neodymium-iron-boron magnet comprises a face-centered cubic (fcc) structure as shown in the FIGURE. The inventors have found that the content of R determines structures of main phase grains and the grain boundary phase of the sintered neodymium-iron-boron magnet, and plays a very important role in properties of the magnet. When the content of R is less than or equal to 29 wt %, an α-Fe phase is easily precipitated in a cooling process of an alloy liquid during smelting, and the existence of the α-Fe phase will lead to a significant decrease in remanence and coercivity of the sintered neodymium-iron-boron magnet; with the increase of the content of R, Br of the magnet gradually decreases, and Hcj gradually increases, and when the content of R is more than or equal to 33 wt %, the thickness of the grain boundary phase is increased, the number of defects and impurities is increased, and the properties of the magnet are greatly reduced.

A main function of B is to form an Nd₂T₁₄B main phase, and changes in the content of B have no significant effect on remanence and coercivity of the sintered neodymium-iron-boron magnet. However, when the content of B is slightly higher (for example, more than or equal to 0.94 wt %), a B-rich phase is easy to form at the grain boundary of the magnet. The B-rich phase is non-ferromagnetic, and the existence of the B-rich phase will greatly reduce the magnetic properties of the magnet.

As the content of Ga decreases, the content of Ga in the main phase grains decreases, and as the atomic number concentration of Ga in the main phase grains decreases, it is less likely to produce an R₆Fe₁₃Ga phase within the grain boundary. As a result, the magnetic properties, in particular Hcj, tend to decrease.

The inventors have found that, in a sintered neodymium-iron-boron magnet with a content of B of not more than 0.94 wt %, the corrosion resistance of the magnet can be improved by controlling the oxygen content to be not less than 400 ppm and not more than 1000 ppm. When the content of Nd in the magnet is constant, a proper oxygen content is favorable for the structure and properties of the sintered neodymium-iron-boron magnet; if the oxygen content is too high (for example, more than or equal to 1000 ppm), the net rare earth metal content of the magnet may be reduced to a critical value, and thus the Nd-rich phase disappears, resulting in failure to densify the magnet during sintering and even appearance of an α-Fe phase due to destruction of the Nd₂T₁₄B main phase. Therefore, an excessively high oxygen content will reduce Hcj of the magnet.

The inventors have further found that the addition of Co can effectively increase the Curie temperature of the sintered neodymium-iron-boron magnet and improve a temperature coefficient of the magnet, which has a great positive effect on the application of the sintered neodymium-iron-boron magnet under high temperature conditions. However, the element Co is a strategic resource that tends to become expensive in the future, and excessive addition of the element Co (for example, more than or equal to 3.0 wt %) will also reduce the toughness of the sintered neodymium-iron-boron magnet, so that the brittleness of the sintered neodymium-iron-boron magnet is increased, which is not beneficial to the processing of magnet products.

The present disclosure further provides a preparation method of the sintered neodymium-iron-boron magnet described above, wherein the method comprises: pulverizing, molding, and sintering the sintered neodymium-iron-boron magnet composition described above to manufacture the sintered neodymium-iron-boron magnet.

According to an embodiment of the present disclosure, the preparation method specifically comprises the following steps:
(1) preparing the sintered neodymium-iron-boron magnet composition described above;
(2) subjecting the sintered neodymium-iron-boron magnet composition described above to a pulverizing procedure to make a micro-powder;
(3) pressing and molding, under the action of an external magnetic field, the micro-powder described above in an inert gas atmosphere to obtain a molded body; and
(4) subjecting the molded body described above to a sintering procedure to obtain the sintered neodymium-iron-boron magnet.

According to an embodiment of the present disclosure, the sintered neodymium-iron-boron magnet composition described above is defined as above. Preferably, the sintered neodymium-iron-boron magnet composition may be a neodymium-iron-boron quick-setting sheet commonly used by those skilled in the art, for example, a quick-setting sheet manufactured by using the following quick-setting process: melting the sintered neodymium-iron-boron magnet composition described above in vacuum or in an inert gas atmosphere to obtain a homogeneous and stable alloy liquid, and pouring the alloy liquid onto a quenching roller to form the quick-setting sheet described above. For example, the pouring is performed at a temperature of 1300-1600° C., more preferably 1400-1500° C. The rotation speed of the quenching roller is preferably 20-60 r/min, and more preferably 30-50 r/min. Preferably, the quenching roller is internally supplied with a cooling fluid, such as cooling water.

According to an embodiment of the present disclosure, in step (2), the micro-powder made by the pulverizing procedure has a Sauter mean diameter (SMD) of 1-10 μm, preferably 1-9 μm, 2-5 μm, and 6-8 μm, and illustratively 2.8 μm. Preferably, the mean diameter of the micro-powder is measured by using a dry dispersion laser diffraction method.

According to an embodiment of the present disclosure, in step (2), the pulverizing procedure further comprises an oxygenation operation.

Preferably, the oxygenation operation has a step as follows: an oxygen-containing mixed gas is introduced in the pulverizing procedure. Preferably, the volume fraction of oxygen in the mixed gas is 0.1%-30%, and preferably 4%-16%.

Preferably, the mixed gas is a mixture of nitrogen or an inert gas with compressed air, wherein the volume fraction of the compressed air in the mixed gas is preferably 20%-80%. Preferably, the inert gas is selected from any one of helium, neon, and argon.

Preferably, the pulverizing procedure comprises hydrogen decrepitation and grinding.

Preferably, after the hydrogen decrepitation, the sintered neodymium-iron-boron magnet composition (preferably a quick-setting sheet) described above bursts to obtain a coarse powder with a mean granularity of 50-150 μm, preferably 100 μm.

Preferably, the hydrogen decrepitation is performed at a vacuum degree of 10-2 Pa. Preferably, high-purity hydrogen (99.999%) is used in the hydrogen decrepitation, with a hydrogen pressure reaching about 105 Pa. Preferably, a dehydrogenation treatment is required after the hydrogen decrepitation and before the grinding.

Preferably, the oxygenation operation may be performed at the hydrogen decrepitation stage, the grinding stage, or any stage after the grinding.

Illustratively, the oxygenation operation occurs at the hydrogen decrepitation stage.

For example, after the coarse powder is obtained by the hydrogen decrepitation and the dehydrogenation is performed, the oxygen-containing mixed gas is introduced for oxygenation, and the coarse powder is recovered.

Preferably, gas-filled cooling and recovery are performed after the oxygenation is completed. Illustratively, the oxygenation operation occurs at the grinding stage, where the oxygen-containing mixed gas described above is introduced for grinding. Further, the grinding further comprises medium grinding and jet micro-grinding. For example, the medium grinding is performed by using a ball mill, such as a 30-mesh sieve. For example, the jet micro-grinding is performed with a jet flow rate of not less than 1 MHz and not greater than 2 MHz.

Illustratively, the oxygenation operation occurs at a stage after the grinding, where a micro-powder storage tank is filled with the oxygen-containing mixed gas described above.

According to an embodiment of the present disclosure, in step (3), in the inert gas atmosphere, the micro-powder is subjected to oriented-pressing molding in a 2T orientation field, preferably a 15 KOe magnetic field.

Preferably, in step (3), a lubricant is added to the micro-powder before the pressing and molding, wherein the amount of the lubricant added accounts for 0-1 wt %, preferably 0.2 wt %, of the total weight of the micro-powder. Preferably, the lubricant is not specified in the present disclosure, and may be selected from those commonly used in the art.

According to an embodiment of the present disclosure, in step (4), the sintering procedure comprises the following steps: high-temperature sintering, cooling, a first aging procedure, cooling, a second aging procedure, and cooling.

Preferably, the high-temperature sintering comprises: a high-temperature sintering temperature of 1000-1100° C. and a high-temperature sintering time of 4-10 h. Preferably, the high-temperature sintering temperature is 1020-1080° C., illustratively 1050° C. Preferably, the high-temperature sintering time is 4-10 h, illustratively 4 h, 5 h, 6 h, 7 h, 8 h, 9 h, or 10 h.

Preferably, the first aging procedure comprises: a treatment temperature of 600-750° C., preferably 630-700° C. or 650-670° C., and a treatment time of 4-10 h, illustratively 4 h, 5 h, 6 h, 7 h, 8 h, 9 h, or 10 h.

Preferably, the second aging procedure comprises: a treatment temperature of 500-650° C., preferably 530-600° C. or 560-580° C., and a treatment time of 4-10 h, illustratively 4 h, 5 h, 6 h, 7 h, 8 h, 9 h, or 10 h.

Preferably, the cooling in the sintering procedure means cooling to a temperature of not higher than 80° C. Preferably, the cooling is selected from any one of vacuum cooling, argon-filled slow cooling, fan cooling, and the like. The cooling described above may be performed at any cooling rate, and slow cooling (for example, less than or equal to 10° C./min) or quenching (for example, greater or equal to 40° C./min) may be selected.

Preferably, the sintering procedure is performed in an inert atmosphere.

The present disclosure further provides a sintered neodymium-iron-boron magnet manufactured by the preparation method described above, and the sintered neodymium-iron-boron magnet has the meaning and content as described above. The sintered neodymium-iron-boron magnet comprises a face-centered cubic (fcc) structure as shown in the FIGURE.

The present disclosure further provides use of the sintered neodymium-iron-boron magnet described above in the fields of wind power, automobiles, home appliances, electric motors, consumer electronics, medical devices, and the like.

### Beneficial Effects

The inventors have found that in the sintered neodymium-iron-boron magnet provided in the present disclosure, part of Nd within the grain boundary combines with oxygen to generate relatively stable neodymium oxide, and the neodymium oxide can play a role in inhibiting abnormal growth of grains; meanwhile, oxygen enters the Nd-rich phase and allows a double hexagonal closest packing (dhcp) structure thereof to be transformed into a face-centered cubic (fcc) structure, as shown in the FIGURE; a wetting angle between grains of a liquid Nd-rich phase and the Nd₂T₁₄B main phase of the fcc-structure becomes smaller, increasing the wettability therebetween, and contributing to more uniform distribution of the Nd-rich phase along the grain boundary. Because the sintered neodymium-iron-boron magnet provided in the present disclosure does not contain a boron-rich phase, and the grain boundary is relatively thick and is capable of inhibiting abnormal growth of grains, the sintered neodymium-iron-boron magnet with suppressed reduction in coercivity and improved coercivity can be obtained by performing the oxygenation operation on the premise of saving the amount of heavy rare earth metals or alloys used, and corrosion resistance of the magnet can be improved.

In addition, the sintering procedure of the present disclosure adopts a two-stage aging process, which further allows Nd in an oxidized state to be distributed in an orderly manner within the grain boundary without reducing the coercivity of the magnet, and is capable of improving corrosion resistance of the magnet.

### BRIEF DESCRIPTION OF THE DRAWING

The FIGURE is a schematic diagram of a face-centered cubic (fcc) structure in a sintered neodymium-iron-boron magnet according to the present disclosure.

### DETAILED DESCRIPTION

The technical solutions of the present disclosure will be further described in detail with reference to the following specific examples. It should be understood that the following examples are merely exemplary illustrations and explanations of the present disclosure, and should not be construed as limiting the protection scope of the present disclosure. All techniques implemented based on the content of the present disclosure described above are included within the protection scope of the present disclosure.

Unless otherwise stated, the starting materials and reagents used in the following examples are all commercially available products, or can be prepared by using known methods.

At the pulverizing stage of the present disclosure, the granularity of the micro-powder after the grinding was not less than 1 μm and not greater than 10 μm, and more preferably not less than 2 μm and not greater than 5 μm. In the examples of the present disclosure, the granularity of the micro-powder was measured by using a dry dispersion laser diffraction method.

The magnetic properties, oxygen content, and weight loss performance of the sintered neodymium-iron-boron magnet were tested as follows:

Magnetic properties: φ10 mm*10 mm sample columns were made, and magnetic properties (including remanence Br, intrinsic coercivity Hcj, and Hk/Hcj) of each sample column were determined by using an NIM62000 B-H plotter. Among them, Hk/Hcj represents a squareness of an intrinsic demagnetization curve of the magnet; a magnetic field corresponding to 0.9 Br or 0.8 Br on the demagnetization curve is generally referred to as a bending-point magnetic field Hk and also referred to as knee-point coercivity, and a larger Hk indicates a better squareness of the intrinsic demagnetization curve of the magnet.

Oxygen content: sample preparation: samples were smashed into particles of about 1-2 mm by mechanical knocking, and oxygen content of each sample column was determined by using an oxygen and nitrogen analyzer; and if the samples were sample columns of the sintered magnet described above, surface coverings of the samples were removed to take internal magnets for sample preparation.

Weight loss performance in PCT: an average loss value of each sample column was determined by using a weighing balance on a high-pressure accelerated life test equipment (PCT chamber) under the following experimental conditions: 121° C., 100% RH, 2.0 Bar, and 96 h.

### Example 1 and Comparative Examples A-E

Sintered neodymium-iron-boron magnets of Example 1 and Comparative Examples A-E were manufactured according to the component proportions in Table 1 and the process conditions in Table 2:

TABLE 1

| Proportion (wt %) of smelting components of sintered | | | | | | | | | | Hydrogen | Medium | Jet | After |
|---|---|---|---|---|---|---|---|---|---|---|---|---|---|
| neodymium-iron-boron magnet | | | | | | | | | | decrepitation | grinding | milling | jet |
| Nd | Pr | Dy | Fe | Co | Cu | Ga | Al | Zr | B | stage | stage | stage | milling |
| 24.80 | 6.20 | 0.50 | 64.85 | 2.00 | 0.15 | 0.30 | 0.15 | 0.16 | 0.89 | ∘ | x | x | x |

Note:
∘ indicates that oxygenation is performed at this stage, and x indicates that oxygenation is not performed at this stage.

TABLE 2

| | | First | | Second | |
|---|---|---|---|---|---|
| | Sintering | aging | First | aging | Second |
| | temper- | temper- | aging | temper- | aging |
| | ature | ature | time | ature | time |
| | (° C.) | (° C.) | (min) | (° C.) | (min) |
| Example 1 | 1055 | 670 | 240 | 560 | 360 |
| Comparative Example A | 1055 | 900 | 240 | 560 | 360 |
| Comparative Example B | 1055 | 800 | 240 | 560 | 360 |
| Comparative Example C | 1055 | 750 | 240 | 560 | 360 |
| Comparative Example D | 1055 | 700 | 240 | 560 | 360 |
| Comparative Example E | 1055 | 630 | 240 | 560 | 360 |

The specific manufacturing processes were as follows:
(1) Preparation of a sintered neodymium-iron-boron magnet composition: A sintered neodymium-iron-boron magnet composition manufactured from the starting materials described above in [Table 1] by using a vacuum induction smelting furnace was placed into a crucible, and heated to 1480° C. in vacuum or in an inert gas (typically argon) atmosphere to be melted into molten steel. The molten steel was then poured onto a quenching roller for rapid cooling and allowed to nucleate, crystallize, and grow gradually on the surface of the roller to form an alloy quick-setting sheet of the sintered neodymium-iron-boron magnet composition. The rotation speed of the quenching roller was not less than 20 r/min and not greater than 60 r/min, more preferably not less than 30 r/min and not greater than 50 r/min, and the quenching roller was internally supplied with cooling water.

The quick-setting sheet described above was taken, and the oxygen content was measured to be 109 ppm.
(2) Pulverization: The alloy quick-setting sheet obtained in step (1) was crushed by hydrogen decrepitation (HD) to obtain a coarse powder.

During recovery of an HD powder, the HD powder was firstly hoisted into a recovery tank, and the recovery tank was replaced by using nitrogen (or an inert gas such as argon, helium, and the like) with a flow rate of 5000+200 L/h for 30 min, cooled for 6 h, then pulled into a cooling device, vacuumized to −0.01 MPa, and filled with a 100+5 kPa mixed gas of nitrogen and compressed air at a volume ratio of 3:2. The recovery tank was cooled for 1 h and then filled with nitrogen to reach one atmospheric pressure, then a fan was turned on for cooling until the temperature was lower than 50° C., and the HD powder was recovered in the recovery tank to complete an oxygenation operation. Then the recovered HD powder was sequentially ground by medium grinding, jet milling, and the like to finally obtain a micro-powder with a Sauter mean diameter (SMD) of 2.8 μm.
(3) Pressing and molding: 0.2 wt % of a lubricant was added to the micro-powder finally obtained in step (2), and after mixing for 2 h by using a mixer, the resulting mixture was poured into a film cavity of a press and subjected to oriented-pressing molding in an inert gas atmosphere under the action of a 2.5 T external magnetic field (such as a 15 Koe magnetic field).
(4) Sintering: A molded body pressed in step (3) was sintered in a vacuum sintering furnace in an Ar atmosphere according to the sintering temperature shown in [Table 2], and then a fan was turned on for quenching to a temperature of not higher than 80° C. to manufacture the sintered neodymium-iron-boron magnet. Then, the magnet was subjected to a first aging procedure according to the first aging temperature and the second aging temperature shown in [Table 2], cooled to a temperature of not higher than 80° C., then subjected to a second aging procedure, and cooled to a temperature of not higher than 80° C. to complete the sintering procedure, thereby obtaining the sintered neodymium-iron-boron magnet.

The magnetic properties, oxygen content, and weight loss performance of the sintered neodymium-iron-boron magnets obtained in Example 1 and Comparative Examples A-E were tested. The test results are summarized in Table 3.

TABLE 3

| | Magnetic property | | | Oxygen | Weight |
|---|---|---|---|---|---|
| | Br | Hcj | Hk/Hcj | content | loss |
| Sample | T | kA/m | — | ppm | mg/cm² |
| Example 1 | 1.397 | 1440 | 0.991 | 629 | 0.28 |
| Comparative | 1.400 | 1347 | 0.977 | 721 | 0.49 |
| Example A | | | | | |
| Comparative | 1.399 | 1397 | 0.985 | 644 | 0.31 |
| Example B | | | | | |
| Comparative | 1.396 | 1373 | 0.983 | 683 | 0.33 |
| Example C | | | | | |
| Comparative | 1.395 | 1404 | 0.981 | 633 | 0.25 |
| Example D | | | | | |
| Comparative | 1.390 | 1320 | 0.942 | 726 | 0.53 |
| Example E | | | | | |

As shown by the test results, for the product in Example 1 of the present disclosure, Br=1.397 T, Hcj=1440 kA/m, Hk/Hcj≥0.95, and the average loss value in PCT is only 0.28 mg/cm². Therefore, excellent magnetic properties and corrosion resistance have been achieved.

### Examples 2-6 and Comparative Example F

TABLE 4

| | Proportion (wt %) of smelting components of | | | | | | | | | Hydrogen | Medium | Jet | After |
|---|---|---|---|---|---|---|---|---|---|---|---|---|---|
| | sintered neodymium-iron-boron magnet | | | | | | | | | decrepitation | grinding | milling | jet |
| | Nd | Pr | Fe | Co | Cu | Ga | Zr | Al | B | stage | stage | stage | milling |
| Example 2 | 26.14 | 6.36 | 64.33 | 2.00 | 0.15 | 0.25 | 0.16 | 0.40 | 0.91 | ∘ | x | x | x |
| Example 3 | 26.14 | 6.36 | 64.33 | 2.00 | 0.15 | 0.25 | 0.16 | 0.40 | 0.91 | x | ∘ | x | x |
| Example 4 | 26.14 | 6.36 | 64.33 | 2.00 | 0.15 | 0.25 | 0.16 | 0.40 | 0.91 | x | x | ∘ | x |
| Example 5 | 26.14 | 6.36 | 64.33 | 2.00 | 0.15 | 0.25 | 0.16 | 0.40 | 0.91 | x | x | ∘ | x |
| Example 6 | 26.14 | 6.36 | 64.33 | 2.00 | 0.15 | 0.25 | 0.16 | 0.40 | 0.91 | x | x | x | ∘ |
| Comparative | 26.14 | 6.36 | 64.33 | 2.00 | 0.15 | 0.25 | 0.16 | 0.40 | 0.91 | x | x | x | x |
| Example F | | | | | | | | | | | | | |

Note:
∘ indicates that oxygenation is performed at this stage, and x indicates that oxygenation is not performed at this stage.

Sintered neodymium-iron-boron magnet composition alloys were manufactured according to the component proportions of the starting materials shown in [Table 4], and sintered neodymium-iron-boron magnets of Examples 2-6 and Comparative Example F were manufactured with reference to the manufacturing processes in Example 1. The differences are that: the sintering temperature was set at 1045° C., the first aging temperature was set at 720° C., the second aging temperature was set at 640° C., and oxygenation operations in Examples 2-6 occurred at different stages of the pulverizing procedure, as described below:

### Example 2

During recovery of an HD coarse powder, the HD coarse powder was firstly hoisted into a recovery tank, and the recovery tank was replaced by using nitrogen (or an inert gas such as argon, helium, and the like) with a flow rate of 5000+200 L/h for 30 min, cooled for 6 h, then pulled into a cooling device, vacuumized to −0.01 MPa, and filled with a 100+5 kPa mixed gas of nitrogen and compressed air at a ratio of 1:1. The recovery tank was cooled for 1 h and then filled with nitrogen to reach one atmospheric pressure, then a fan was turned on for cooling until the temperature was lower than 50° C., and the HD powder was recovered in the recovery tank to complete the oxygenation operation.

### Example 3

At a medium grinding stage, a 30-mesh sieve was used, and grinding was performed in a nitrogen-oxygen mixed gas atmosphere containing oxygen at a volume ratio of 10%+1% in a medium grinding cavity to complete the oxygenation operation.

### Example 4

At a jet milling stage, grinding was performed in a nitrogen-oxygen mixed gas atmosphere containing oxygen at a volume ratio of 12%+1% in a jet milling cavity to complete the oxygenation operation.

### Example 5

At a jet milling stage, a jet milling pipeline was adjusted, and one of the grinding nitrogen pipes was changed into a nitrogen-oxygen mixed gas pipe containing 1%+0.1% oxygen for grinding to complete the oxygenation operation.

### Example 6

At a powder mixing stage after jet milling, gas in a jet-milled powder storage tank was replaced, and the tank was filled with a nitrogen-oxygen mixed gas containing oxygen at a volume ratio of 13%+1% to complete the oxygenation operation.

### Comparative Example F

The oxygenation operation did not occur in the pulverizing procedure, and the recovery and grinding (including medium grinding, jet milling, mixing, and the like) of an HD coarse powder were performed in a nitrogen atmosphere.

In Examples 2-6 and Comparative Example F, micro-powders with a Sauter mean diameter (SMD) of 2.8 μm were finally manufactured.

The magnetic properties, oxygen content, and weight loss performance of the sintered neodymium-iron-boron magnets obtained in Examples 2-6 and Comparative Example F were tested.

The test results are summarized in Table 5.

TABLE 5

| | Magnetic property | | | Oxygen | Weight |
|---|---|---|---|---|---|
| | Br | Hcj | Hk/Hcj | content | loss |
| | T | kA/m | — | ppm | % |
| Example 2 | 1.353 | 1448 | 0.986 | 832 | 0.26 |
| Example 3 | 1.357 | 1440 | 0.984 | 785 | 0.28 |
| Example 4 | 1.352 | 1444 | 0.984 | 679 | 0.25 |
| Example 5 | 1.353 | 1445 | 0.988 | 682 | 0.29 |
| Example 6 | 1.356 | 1445 | 0.981 | 465 | 0.57 |
| Comparative | 1.356 | 1469 | 0.979 | 328 | 6.51 |
| Example F | | | | | |

The results show that, for the sintered magnets in the examples of the present disclosure, the oxygen content was controlled to be not less than 400 ppm and not greater than 1000 ppm, the magnetic properties of Br, Hcj and Hk/Hcj were comparable, the weight loss in PCT was less than 2.0%, and the corrosion resistance was excellent. However, in Comparative Example F, in which a conventional pulverizing procedure was used, the oxygenation operation was not performed in the pulverizing procedure, the oxygen content was only 328 ppm, the weight loss in PCT was as high as 6.51%, and the corrosion resistance of the magnet was poor.

The foregoing description is merely exemplary illustration of embodiments of the present disclosure, and is not intended to limit the protection scope of the present disclosure in any way. Any person skilled in the art can make amendments, equivalent changes, and modifications to the technical solutions of the present disclosure without departing from the spirit and teaching of the present disclosure, and such amendments, equivalent changes, and modifications should still fall within the protection scope of the present disclosure.

1. A sintered neodymium-iron-boron magnet, wherein the sintered neodymium-iron-boron magnet is manufactured by pulverizing, molding, and sintering a sintered neodymium-iron-boron magnet composition under a protection of an inert atmosphere;
the sintered neodymium-iron-boron magnet comprises:
R having a content of not less than 28.5 wt % and not more than 32.5 wt %;
B having a content of not less than 0.88 wt % and not more than 0.94 wt %;
Ga having a content of not less than 0.1 wt % and not more than 0.3 wt %;
Co having a content of not less than 1.0 wt % and not more than 3.0 wt %;
O having a content of not less than 400 ppm and not more than 1000 ppm; and
the balance being Fe and inevitable impurities.

2. The sintered neodymium-iron-boron magnet as claimed in claim 1, wherein the R is selected from neodymium (Nd), or neodymium (Nd) and at least one of the following rare earth elements: rare earth elements such as lanthanum (La), cerium (Ce), praseodymium (Pr), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), scandium (Sc), yttrium (Y), and the like.

3. The sintered neodymium-iron-boron magnet as claimed in claim 1, wherein B, Ga, and O in the sintered neodymium-iron-boron magnet have a relationship as follows: 0.25×(0.98−[B])+0.1×(0.5−[Ga])<[O],
wherein [B], [Ga], and [O] represent mass percentages of B, Ga, and O in the sintered neodymium-iron-boron magnet, respectively;
preferably, the content of the impurities is not less than 0 wt % and not more than 2.0 wt %, and preferably not less than 0.1 wt % and not more than 0.8 wt %.

4. The sintered neodymium-iron-boron magnet as claimed in claim 1, wherein the sintered neodymium-iron-boron magnet composition contains no more than 200 ppm of O; preferably, the sintered neodymium-iron-boron magnet composition further contains a desired stoichiometric amount of elements such as R, B, Ga, Co, Fe, and the like.

5. The sintered neodymium-iron-boron magnet as claimed in claim 1, wherein the sintered neodymium-iron-boron magnet comprises an R₂Fe₁₄B main phase, an R-rich phase, and a B-rich phase;
preferably, the sintered neodymium-iron-boron magnet comprises a face-centered cubic (fcc) structure as shown in the FIGURE.

6. A preparation method of the sintered neodymium-iron-boron magnet as claimed in claim 1, wherein the preparation method comprises:
pulverizing, molding, and sintering the sintered neodymium-iron-boron magnet composition to manufacture the sintered neodymium-iron-boron magnet;
preferably, the preparation method of the sintered neodymium-iron-boron magnet specifically comprises the following steps:
(1) preparing the sintered neodymium-iron-boron magnet composition;
(2) subjecting the sintered neodymium-iron-boron magnet composition to a pulverizing procedure to make a micro-powder;
(3) pressing and molding, under the action of an external magnetic field, the micro-powder in an inert gas atmosphere to obtain a molded body; and
(4) subjecting the molded body to a sintering procedure to obtain the sintered neodymium-iron-boron magnet.

7. The preparation method of the sintered neodymium-iron-boron magnet as claimed in claim 6, wherein in step (2), the micro-powder made by the pulverizing procedure has a Sauter mean diameter (SMD) of 1-10 μm;
preferably, in step (2), the pulverizing procedure further comprises an oxygenation operation;
preferably, the oxygenation operation has a step as follows: an oxygen-containing mixed gas is introduced in the pulverizing procedure; preferably, the volume fraction of oxygen in the mixed gas is 0.1%-30%, and preferably 4%-16%; preferably, the mixed gas is a mixture of nitrogen or an inert gas with compressed air, wherein the volume fraction of the compressed air in the mixed gas is preferably 20%-80%; and preferably, the inert gas is selected from any one of helium, neon, and argon;
preferably, the pulverizing procedure comprises hydrogen decrepitation and grinding;
preferably, the oxygenation operation may be performed at the hydrogen decrepitation stage, the grinding stage, or any stage after the grinding.

8. The preparation method of the sintered neodymium-iron-boron magnet as claimed in claim 6, wherein in step (3), the micro-powder is subjected to oriented-pressing molding in a 2T orientation field, preferably a 15 KOe magnetic field; preferably, in step (3), a lubricant is added to the micro-powder before the pressing and molding, wherein the amount of the lubricant added accounts for 0-1 wt % of the total weight of the micro-powder.

9. The preparation method of the sintered neodymium-iron-boron magnet as claimed in claim 6, wherein in step (4), the sintering procedure comprises the following steps: high-temperature sintering, cooling, a first aging procedure, cooling, a second aging procedure, and cooling;
preferably, the high-temperature sintering comprises: a high-temperature sintering temperature of 1000-1100° C. and a high-temperature sintering time of 4-10 h;
preferably, the first aging procedure comprises: a treatment temperature of 600-750° C. and a treatment time of 4-10 h;
preferably, the second aging procedure comprises: a treatment temperature of 500-650° C. and a treatment time of 4-10 h;
preferably, the cooling in the sintering procedure means cooling to a temperature of not higher than 80° C.; preferably, the cooling is selected from any one of vacuum cooling, argon-filled slow cooling, fan cooling, and the like;
preferably, the sintering procedure is performed in an inert atmosphere.

10. Use of the sintered neodymium-iron-boron magnet as claimed in claim 1 in the fields of wind power, automobiles, home appliances, electric motors, consumer electronics, medical devices, and the like.
